(19) United States
(12) Patent Application Publication
(10) Pub. No.: US 2007/0214136 A1
(43) Pub. Date: Sep. 13, 2007

(54) Data mining diagramming

(75) Inventors: C. James MacLennan, Redmond, WA (US); Shuvro Mitra Mazumder, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/374,269

(22) Filed: Mar. 13, 2006

(51) Int. Cl. G06F 17/30

(52) U.S. Cl. 707/6

(57) ABSTRACT

A unique system and method that facilitates diagramming data mining output to create an interactive rendering of the output are provided. The system and method involve a diagramming system that includes various data mining templates such as decision tree and dependency network templates. When a template is dragged to a work space in the diagramming system, selection of a data source, a model, and one or more rendering options can be made before the model is rendered. The model is interactive, thus it can be modified and annotated apart or separate from the context of the data mining engine or viewer. As a result, users can more readily incorporate such rendered models into other applications such as presentations and can continue to interact with them. Examples of interactions include changing node color, content, connection points, page location, size or shape, and shading and performing tree operations or dependency net operations.

### BACKGROUND

Data mining refers to the practice of automatically searching large stores of data for patterns or trends. Many types of businesses make use of data mining in some aspect to learn more about their clients to better service or anticipate their needs or to learn more about their customers such as their buying habits in conjunction with their demographic information. For example, market basket analysis is a relatively common technique currently in use by retailers. In order to achieve additional sales and ultimately higher profits, many retailers study their customers' behaviors when it comes to their purchases. They analyze buying patterns, style trends, price point thresholds, product placement, and product pairing for their stores or online sites. One aspect of market basket analysis specifically involves studying the items most often purchased together so that the retailers can better position certain products near each other to further optimize sales as well as to make shopping more convenient for their customers.

Thus, data mining plays an important role for many different retail industries because it can provide a wealth of information that may otherwise be unrealized or unknown. Many data mining tools can provide visual models of the relationships between various types of data and/or the content of the data such as by data mining viewers. However, these visual models are relatively limited in their use and cannot be modified in any way once they are incorporated into any other application document or presentation tool.

### SUMMARY

The following presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

The subject application relates to a system(s) and/or methodology that facilitate interacting with a graphical visualization of a model generated by data mining. In particular, the system and method provide for modifying and/or annotating the graphical visualization of the model, and thus for interacting with it in a number of aspects. As a result, a user can readily incorporate it into another application such as in part of a slide show presentation or report document and can continue to interact with the visualization in terms of adding or changing color, titles, shading, font, content, node connections, node placement, annotations, and/or otherwise changing the content or appearance.

Traditional tools that are currently available lack these capabilities. For example, with the current techniques, once the visualization is incorporated into another application, most useful types of interaction are not possible because the visualization is treated like an image (e.g., bitmap). Therefore, the content of the image cannot be altered in any way. On the contrary, the subject system and method facilitate visualizing the modeled data and allowing an application of embellishments or themes as well as the performance of various tree or net operations depending on the model type. Many other types of interactions with the model are also possible. Some of these include controlling link visibility and determining which nodes are visible and which are hidden, bringing nodes back into view, moving nodes off the page, and interrogating nodes.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a diagramming system that facilitates providing interactive graphical visualizations of models obtained via data mining.

FIG. 2 is a block diagram of a diagramming system that facilitates providing interactive graphical visualizations of models obtained via data mining.

FIG. 3 is an exemplary user interface of a diagram component and a plurality of available templates that can be employed to generate an interactive visualization of the model.

FIG. 4 is an exemplary user interface of a data mining engine selection menu wherein a user can select the data mining engine as well as the desired database to mine.

FIG. 5 is an exemplary user interface that demonstrates rendering an interactive decision tree in part by the selection of a model from the database apart from any data mining viewers.

FIG. 6 is an exemplary user interface that demonstrates a rendering options menu.

FIG. 7 is an exemplary user interface that demonstrates a partial view of an interactive decision tree that has been rendered by the diagramming system of FIGS. 1 and/or 2.

FIG. 8 is an exemplary user interface that demonstrates a zoomed out view of the interactive decision tree in FIG. 7 which has been rendered by the diagramming system of FIGS. 1 and/or 2.

FIG. 9 is an exemplary user interface that demonstrates a full view of the interactive decision tree in FIGS. 7 and/or 8 that has been rendered by the diagramming system of FIGS. 1 and/or 2.

FIG. 10 is an exemplary user interface that demonstrates a pop-up menu that can appear when a node is clicked on to further modify or alter the content of the node or connections to or from the node or placement of the node.

FIG. 11 is an exemplary user interface that demonstrates a partial view of an interactive decision tree rendered by the diagram system of FIGS. 1 and/or 2 and that has been annotated and/or modified apart from a data mining model generator.

FIG. 12 is an exemplary user interface that demonstrates a partial view of an interactive dependency (net) network that has been rendered by the diagramming system of FIGS. 1 and/or 2.

FIG. 13 is an exemplary user interface that demonstrates a more zoomed out view of the interactive dependency network in FIG. 12.

FIG. 14 is an exemplary user interface that demonstrates a pop-up menu that can appear when an interactive dependency net node is clicked on to further modify or alter the content of the node, any connections to or from the node, or the placement of the node.

FIG. 15 is an exemplary user interface that demonstrates a partial view of an interactive dependency (net) network that has been modified.

FIG. 16 is a flow diagram illustrating an exemplary methodology that facilitates interacting with graphical visualizations of models generated via data mining apart from the data mining tools.

FIG. 17 is a flow diagram illustrating an exemplary methodology that facilitates modifying and/or annotating graphical visualizations of models generated via data mining apart from the data mining tools such as when incorporated into other applications.

FIG. 18 illustrates an exemplary environment for implementing various aspects of the invention.

### DETAILED DESCRIPTION

The subject systems and/or methods are now described with reference to the drawings, wherein like reference numerals are used to refer to like elements throughout. In the following description, for purposes of explanation, numerous specific details are set forth in order to provide a thorough understanding of the systems and/or methods. It may be evident, however, that the subject systems and/or methods may be practiced without these specific details. In other instances, well-known structures and devices are shown in block diagram form in order to facilitate describing them.

As used herein, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers.

Conventional data mining tools perform various analyses on data. A model is one type of output of data mining which can be viewed graphically such as in the form of a decision tree or dependency network using a data mining viewer (e.g., tree viewer or net viewer). The graphical views of the model can be displayed on a client control, for example, that permits user interaction. Some examples of user interaction include but are not limited to expanding and collapsing nodes, moving connection points, and/or hiding various nodes based on rule strength. Color choice and shading control can also be adjusted by the user in these data mining tools.

Oftentimes, many users want to present their work to others by including at least some part of the decision tree or dependency network into other document or presentation applications. However, the decision tree, for instance, can only be incorporated into another presentation or document application as an image (e.g., bitmap). Thus, no further interaction with the content of the decision tree can be performed using the conventional data mining tools and related viewers. By way of example, imagine that the decision tree has been incorporated into a slide show presentation. The conventional viewers do not permit modification of the contents of the tree. Annotations cannot be made, color and shading cannot be changed, and nodes cannot be expanded or collapsed to emphasize strengths or certain patterns. Hence, the tree and its contents can only be viewed in a static manner.

To mitigate many of these problems, the subject application involves a diagramming system that provides an interactive service to diagram data mining output. More specifically, the system (and related methods) affords a means for rendering and interacting with data mining models such as decision trees and dependency networks apart from a standard data mining viewer and tool. As a result, the model can be modified, annotated, or visually enhanced and incorporated into any other application or document as an interactive model. The following figures discussed below demonstrate the systems and methods that accomplish this. In addition, exemplary user interfaces are provided to assist in illustrating the interactive capabilities of the diagramming system with respect to the data mining models.

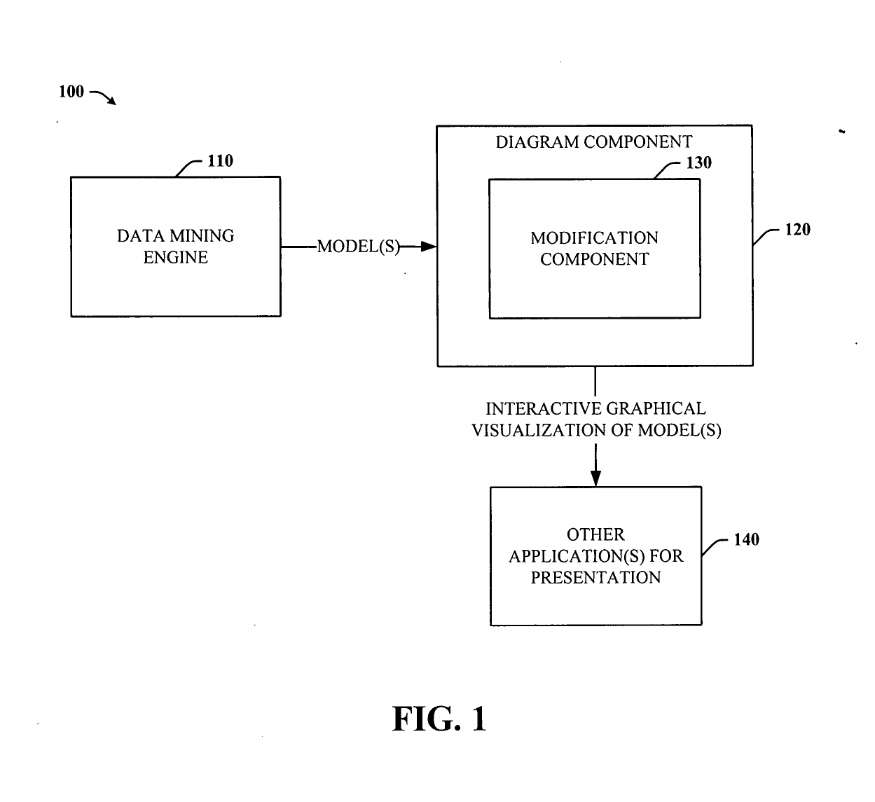

Referring now to FIG. 1, there is a general block diagram a diagramming system 100 that facilitates providing interactive graphical visualizations of models obtained via data mining. The system includes a data mining engine 1 10 that examines and analyzes one or more sets of data and generates output to demonstrate correlations and relationships between data. The output can be represented graphically such as by a decision tree or dependency network via a diagram component 120. The diagram component 120 can create an interactive rendering of the output that can be modified and annotated in a variety of ways to optimize visualization of the output.

More specifically, the diagram component 120 includes at least one template which can be selected according to the desired rendering (e.g., tree or network). When the appropriate template is selected and dragged into a work or display space, communication with the data mining engine can be established. In particular, a database connection can be made between the diagram component 120 and the data mining engine 110. Thus, data source can be selected as well as the preferred model and the model can be rendered by the diagram component 120 in an interactive environment to effectively create an interactive model. It should be appreciated that the data source “live” in various databases in the data mining engine 110 but can be rendered in various interactive forms using the diagram component 120.

A modification component 130 can be employed to make any changes to the model such as, for example, adding color, altering shading, annotating comments to one or more nodes or to a cluster of nodes, changing titles, changing node content, etc. The diagram component 120 can also include other controls that can assist the user in changing viewing options for the decision tree or dependency network and that can also refresh the rendering after options have been changed or updated. When desirable, the interactive decision tree or dependency network can be incorporated into other applications 140 such as for presentations. Though not specifically discussed, it should also be appreciated that the model can be rendered and viewed by the data mining viewer as well under the restrictions of such conventional data mining viewers.

In practice, for example, imagine that a user opens the diagram component 120 and selects a decision tree template by dragging it onto the work space. This action can prompt the user to select a database connection, select a tree to render, and specify rendering options (e.g., type of tree, depth/number of levels to show, shading, background, etc.). Once the decision tree is rendered, the user can annotate and/or modify the tree using any modification tools available by the modification component 130. In addition, the user can perform different decision tree operations such as expand or collapse nodes, move nodes (e.g., children) to a new page using off-page connectors, and interrogate nodes through a custom user interface initiated from each node. The original creation user interface can be viewed again through the diagram (e.g., tree) title where the user can change options and refresh the tree.

There are many different architectural scenarios for the data mining engine 110 and diagram component 120. For example, the data mining engine can be located on a server and the diagram component can be located on a client machine. Alternatively, both can be maintained on the server or on the client. In some cases, the diagram component's decision tree template may require that the database client components be installed on the client machine for the initial diagram rendering and set-up. However, the decision tree template can work against server, client (local), and session models. Furthermore, the template can maintain an open connection with another application such as a spreadsheet tool (e.g., used for data mining).

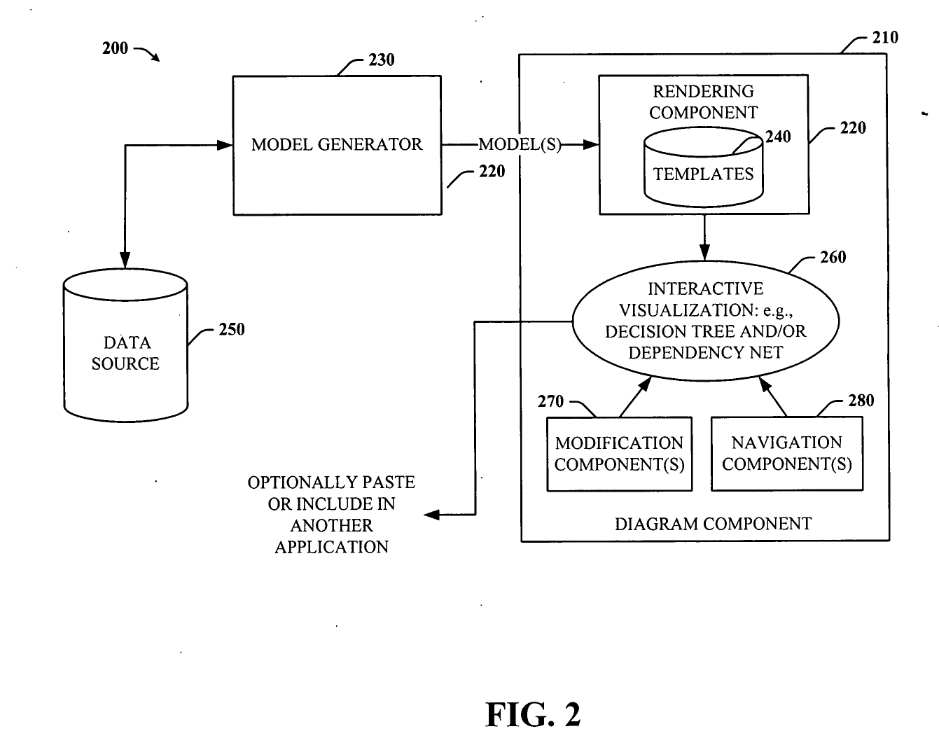

Referring now to FIG. 2, there is a block diagram of a diagramming system 200 that facilitates providing interactive graphical visualizations of models obtained via data mining. In particular, the system 200 includes a diagram component 210 that can produce diagrams of modeled data through the use of a rendering component 220. The rendering component 220 renders a selected model that has been generated by a model generator 230 according to a selected template (240). For example, using menus in the diagram component 210, the user can select and drag a template 240 to the workspace. The template 240 may represent a decision tree or a dependency network. Template selection can prompt the user to select a database to connect to in order to obtain the desired data source 250 to render.

The resulting rendering is an interactive graphical visualization of a model 260 such as a decision tree or dependency network. The diagram is interactive and thus can be modified and/or annotated as desired by the user to emphasize significant nodes or relationships or to minimize the view of or completely hide less important nodes. One or more modification components 270 can be employed to add or modify color, shading, font, the legend, labels, annotations, and/or node contents. Furthermore, one or more navigation components 280 can be employed to expand or collapse nodes, to increase or decrease the number of levels visible, and/or to move nodes on the page or to different pages. In addition, a slider control can be employed to hide or make visible one or more nodes based on their (rule) strength. For instance, nodes associated with weaker rules may disappear from view as the slider control is moved up or down or right or left.

Thus, the model can be graphically rendered, viewed, and modified apart from the data mining engine and viewer. The interactive model from the diagram component 210 can also be pasted in or otherwise incorporated in another application. For example, suppose a user is preparing a slide show presentation for a large organic foods retailer to assist them in improving sales. The presentation includes a market basket analysis for which the user has used a data mining engine to analyze customer data, their shopping lists, dollars spent per trip, items purchased, prices of items when they were purchased, the locations of the items in the store when purchased, and/or promotions held during that time, etc. To view the results of the data mining engine, the user can render a decision tree to analyze the consumers and their shopping habits such as in terms of age groups, home demographics (e.g., marital status, kids, etc.), occupation, and income range. Once the tree has been rendered, the user can highlight certain nodes using color and make annotations regarding others to provide some interpretation guidance to the retailer. To include this tree in his presentation, the user can copy and paste it into the slide show presentation, where it will remain as an interactive element. That is, the user can still modify, annotate, and/or navigate the tree (or dependency network)—apart from the data mining engine.

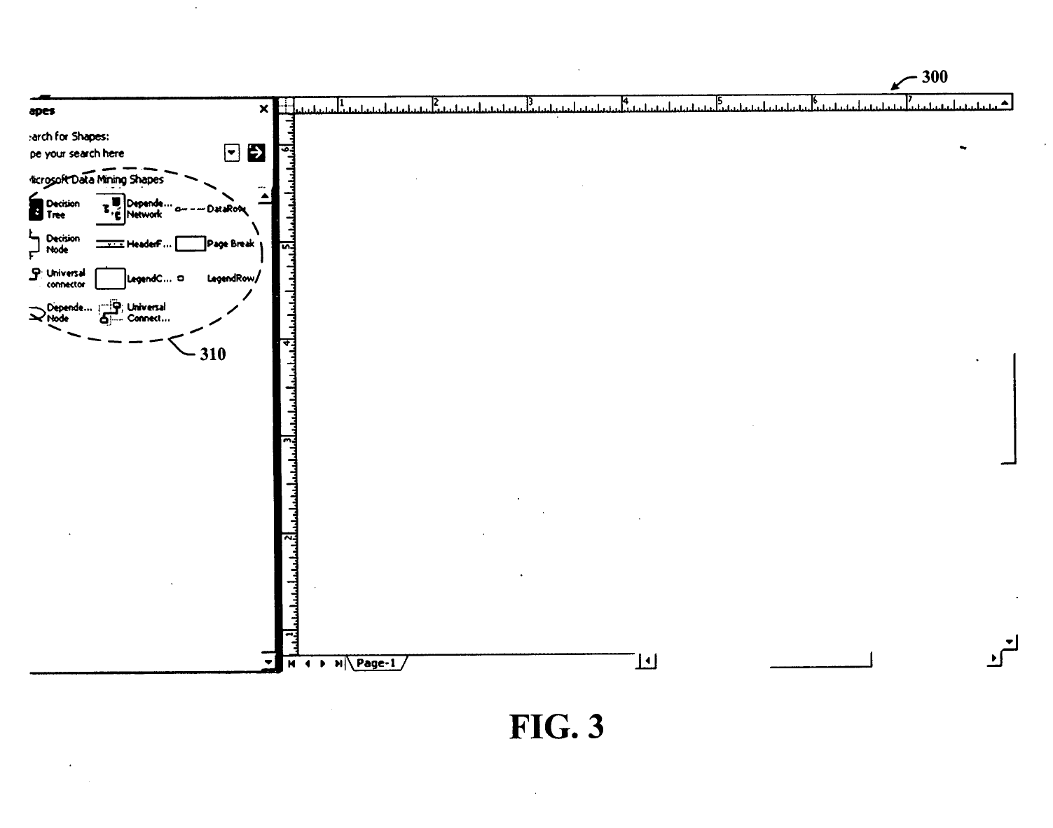

Turning now to FIGS. 3-15, there are a series of user interfaces that demonstrate various aspects of the subject diagram system as described in FIGS. 1 and 2, supra. As noted with each of the following figures, they are merely exemplary views of the user interface in connection with rendering a model generated from data mining and interacting with such model outside of the data mining engine or viewer.

Beginning with FIG. 3, there is an exemplary user interface 300 of a diagram component and a plurality of available templates 310 that can be employed to generate an interactive visualization of the model. For example, the templates 310 can include but are not limited to a decision tree template and a dependency network template. Tree nodes and/or network nodes can be added to an existing rendering as well. Furthermore, connections between nodes can be created, modified, or deleted altogether.

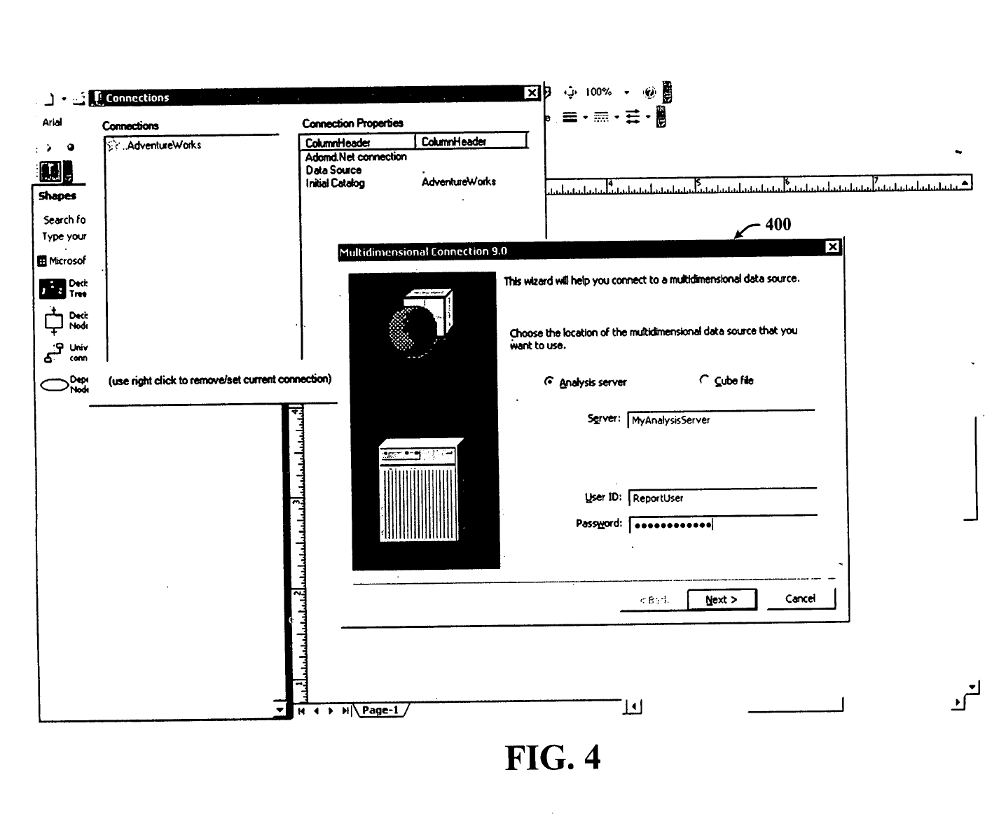

When a tree or network template is selected, a connection UI wizard 400 can be triggered as shown in FIG. 4 to guide the user through the rendering process. The exemplary user interface in FIG. 4 illustrates a database connection selection menu (400) wherein a user can connect to a data mining engine and select a data source for mining. In particular, the user can select to access a server or a cube file and then can indicate a specific name of the server or file.

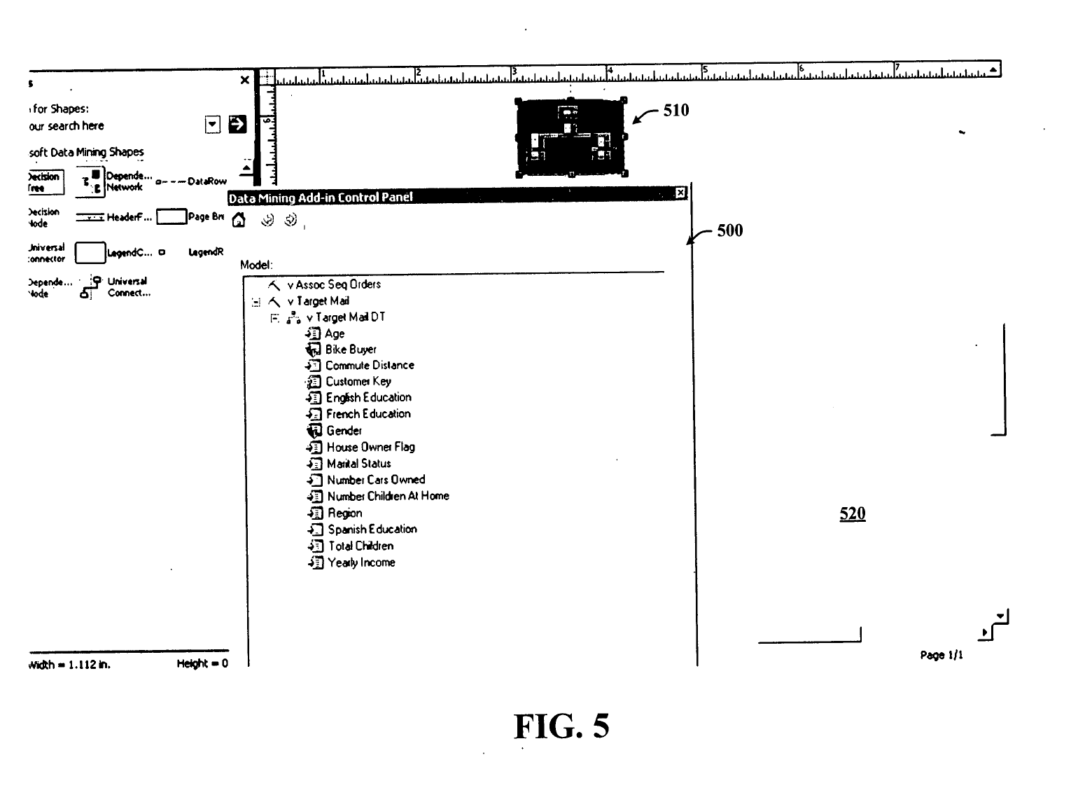

Once the data source is chosen, one or more models from the selected database may be presented to the user as depicted in the window or interface 500 in FIG. 5. More specifically, this user interface 500 demonstrates the model selection phase of the rendering process. It should be noted that the user initially dragged the decision tree image 510 shown in the work or display space 520 to the space 520 from a “shapes” window, thus triggering the rendering process. Here, the model can be rendered in the space 520 and separate from any rendering of the same that may occur in the data mining viewer/tool. As shown in the figure, the mining model is called “v Target Mail DT” and many nodes fall beneath it having titles such as Age, Bike Buyer, Gender, Region, and Spanish Education.

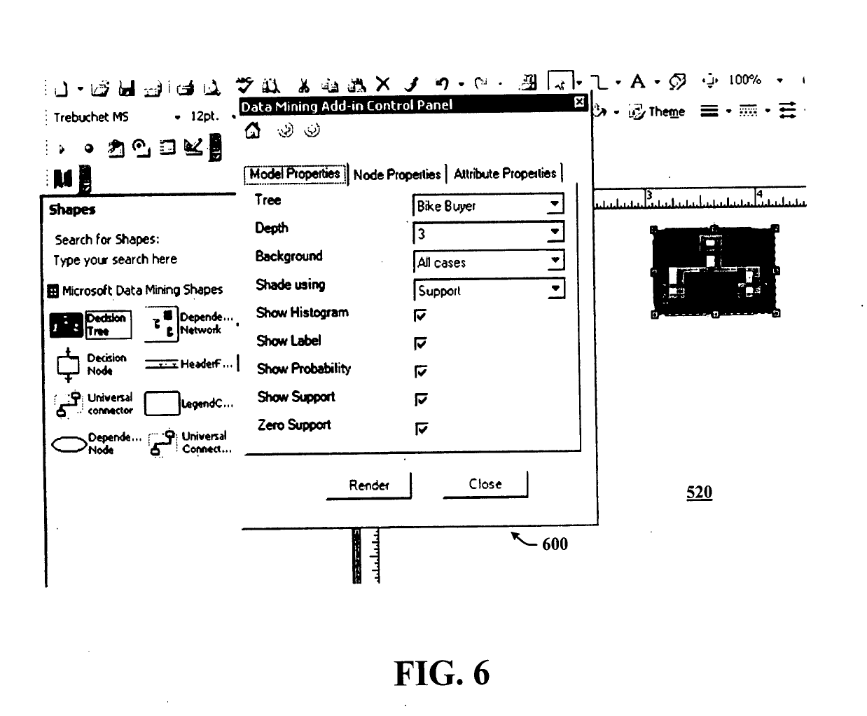

Moving on to FIG. 6, the user can select which tree (e.g., Bike Buyer) to focus the rendering around as well as many other model properties, node properties, and node attributes using an exemplary rendering options menu 600. In addition to selecting the tree, the depth of the tree, shading, and the showing of histograms, labels, probabilities, and support can be chosen as well. Finally, the user can select “Render” on the menu 600 in order to actually render the model in the work space (520).

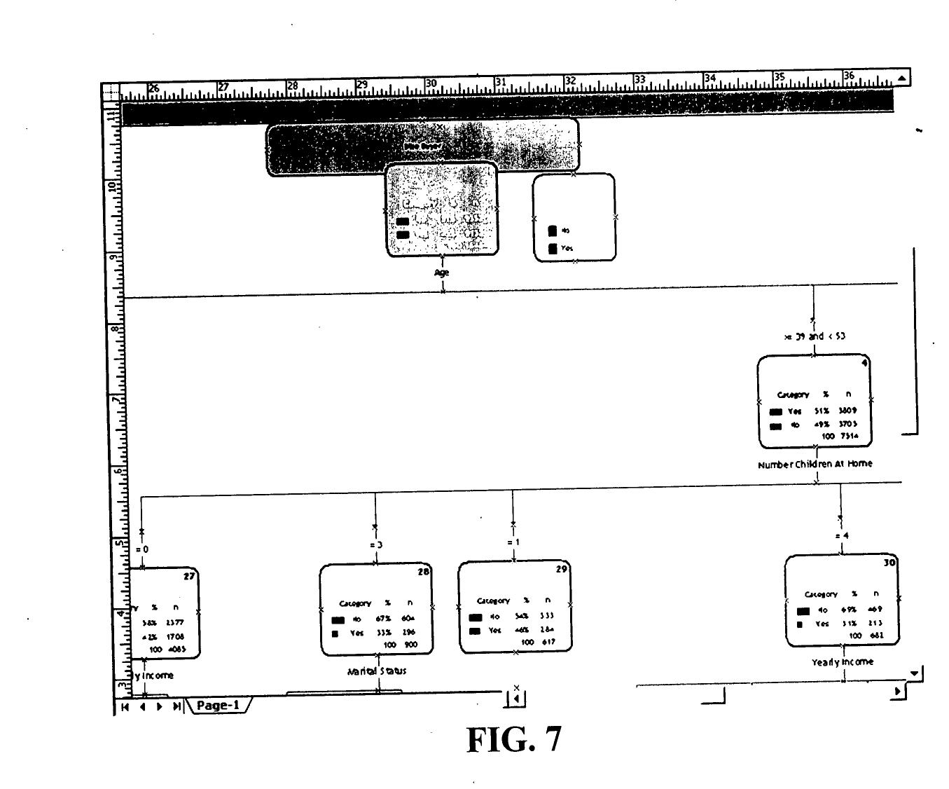

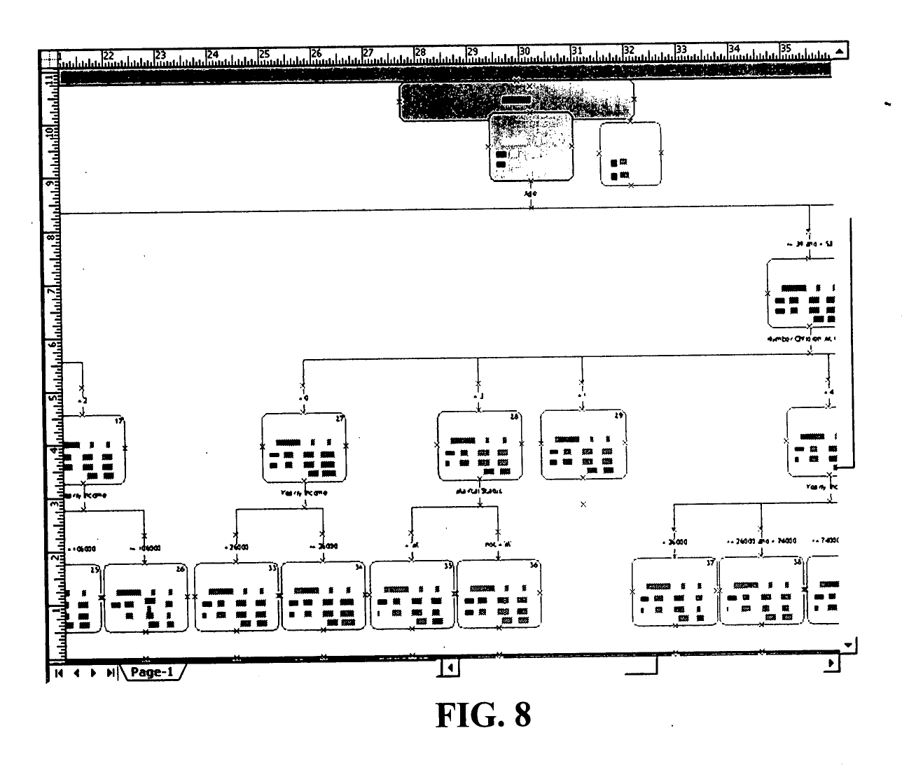

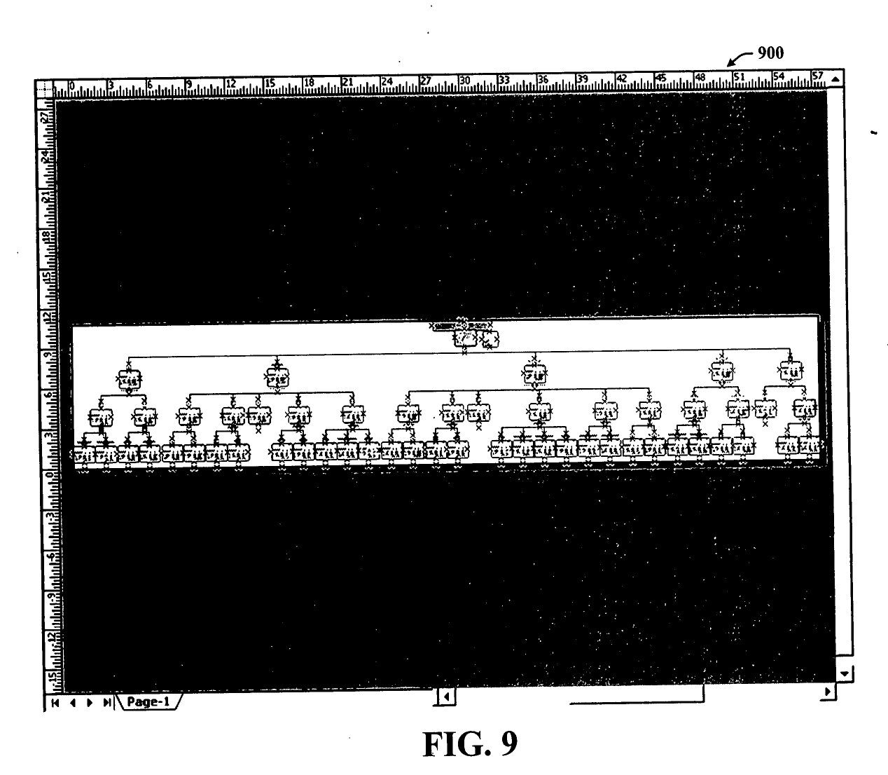

FIG. 7 represents a partial view of an interactive decision tree that has been rendered by the diagramming system of FIGS. 1 and/or 2. In particular, the tree is rendered in a top down manner where “Bike Buyer” is at the top and appears in a much darker shade than the surrounding nodes that are visible. To view greater detail and less of the overall tree, the user can zoom in on the current view. This may be helpful when modifying a node or annotating the area around a node. To view more of the interactive tree and therefore less detail, the user can adjust the current view by zooming out or adjusting the relative viewing size of the tree. FIG. 8 demonstrates a partially zoomed out view of the interactive tree in FIG. 7. The whole interactive tree 900 can be viewed as shown in FIG. 9 in far less detail than shown in FIGS. 7 and 8. However, in this view (FIG. 9) various patterns may be more visible and additional conclusions can be drawn. This may be particularly true after adding color or making other visual modifications to the tree to emphasize certain nodes.

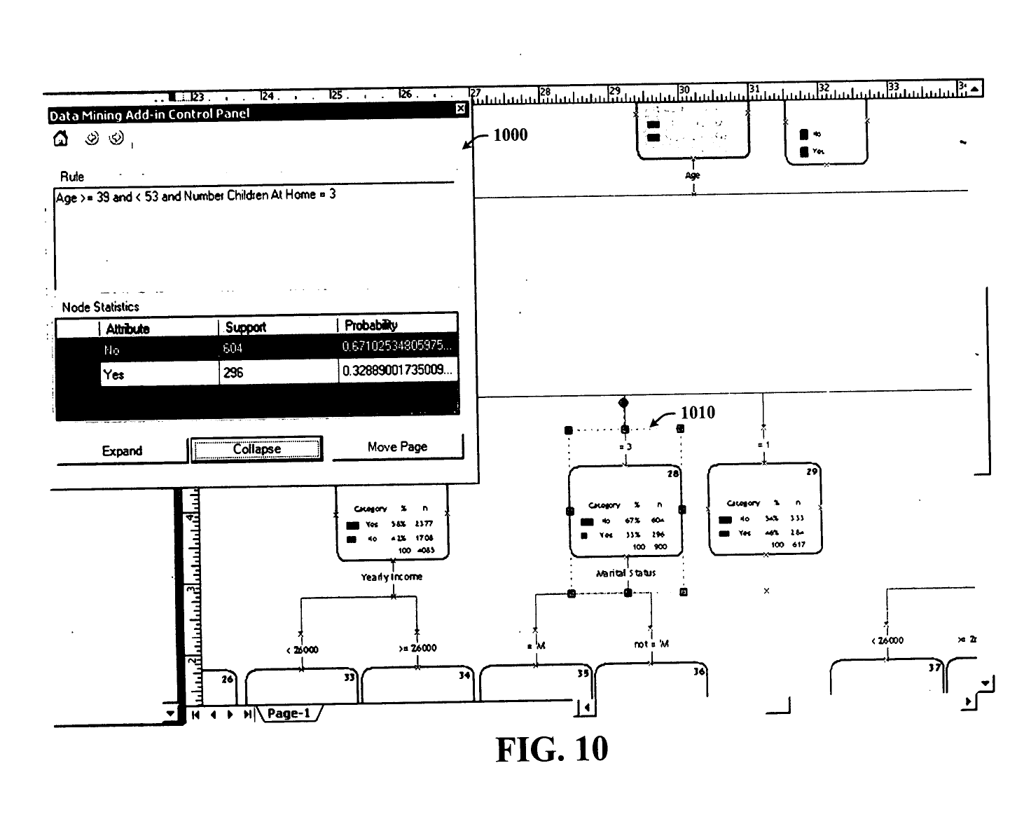

As mentioned earlier, the data mining output as rendered by the diagramming system (100, 200) can be modified in many different ways and can remain interactive and thus modifiable even when incorporated into third party applications or documents. FIG. 10 includes an exemplary user interface that demonstrates a menu 1000 that can appear when a node is clicked on to further modify or alter the content of the node, connections to or from the node, or placement of the node. For example, when right clicking on the highlighted node 1010, a control panel or menu 1000 can appear to show various characteristics of the highlighted node, the rule associated with the node, and options for modifying or navigating about the node. Here, the node can be expanded or collapsed depending on its current state or moved to another page.

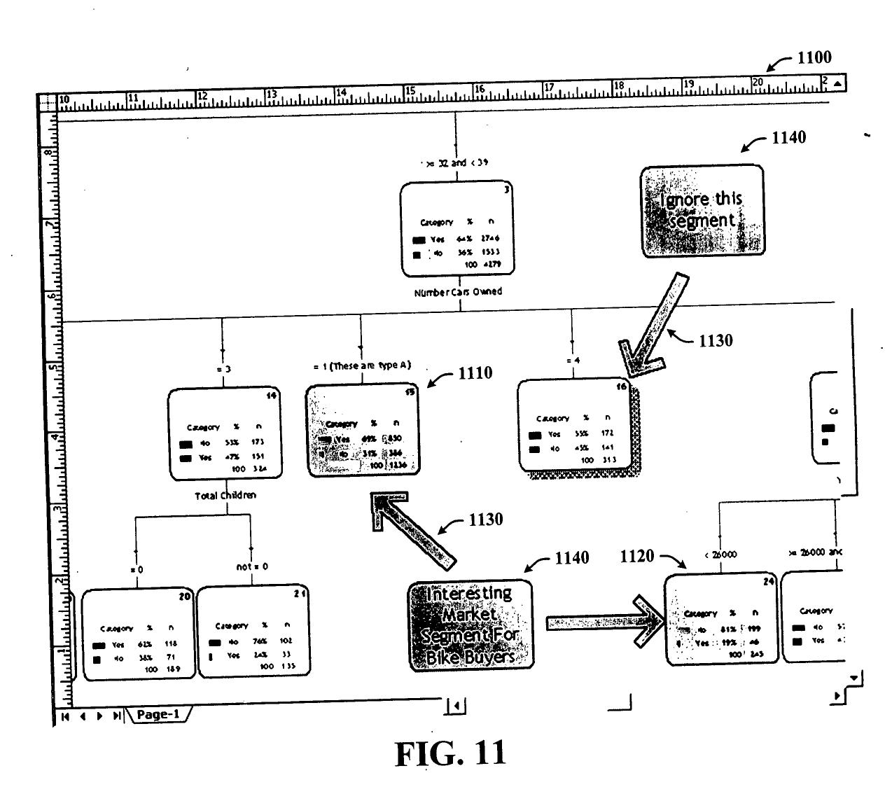

Turning now to FIG. 11, the partial view 1 100 of the tree (from FIGS. 7-10) is depicted following modification and annotation—apart from the data mining viewer/tool. In particular, nodes 1110 and 1120 have been colored yellow and arrows 1130 with adjoining comments or remarks 1140 have been added to the tree. It should be appreciated that any color can be employed and arrows and remarks can be added, removed, and/or modified as needed. Furthermore, the font in the remarks can be changed as desired. Though not shown in the figure, the user can also switch views of the tree by hiding certain modifications or annotations and then allowing them to reappear when desired. For example, during one part of the user's presentation, the user may wish to show the tree without any modification or with only a subset of the modifications and annotations made. As the user proceeds, he can either hide or make the modifications and/or annotations visible in a progressive manner. By being able to modify and otherwise interact with the data mining output in this manner, the output becomes more flexible in its use.

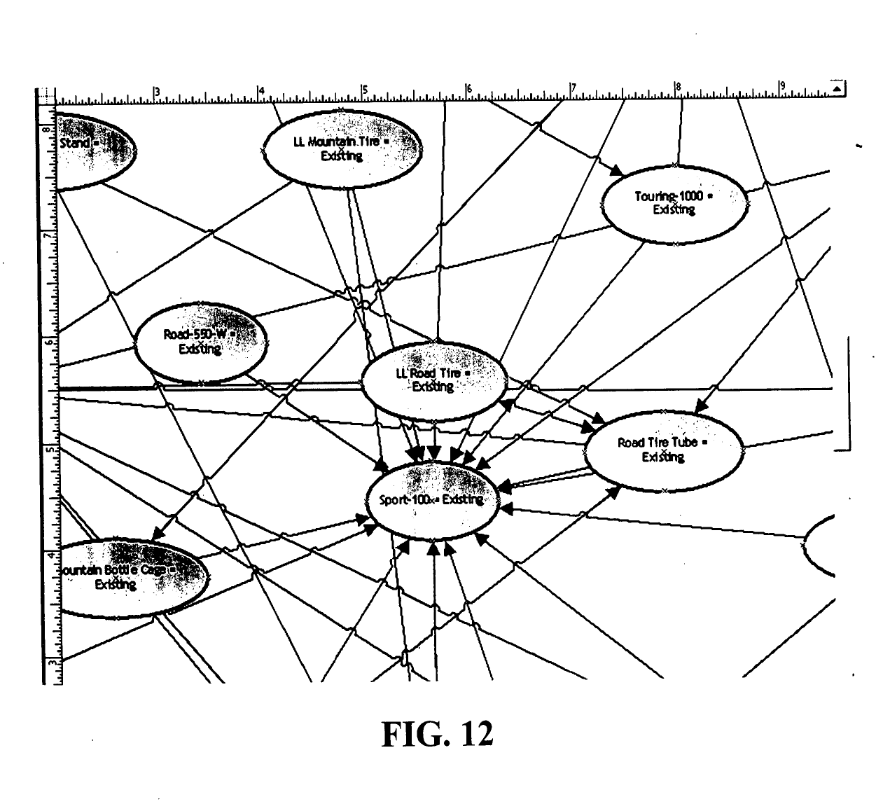

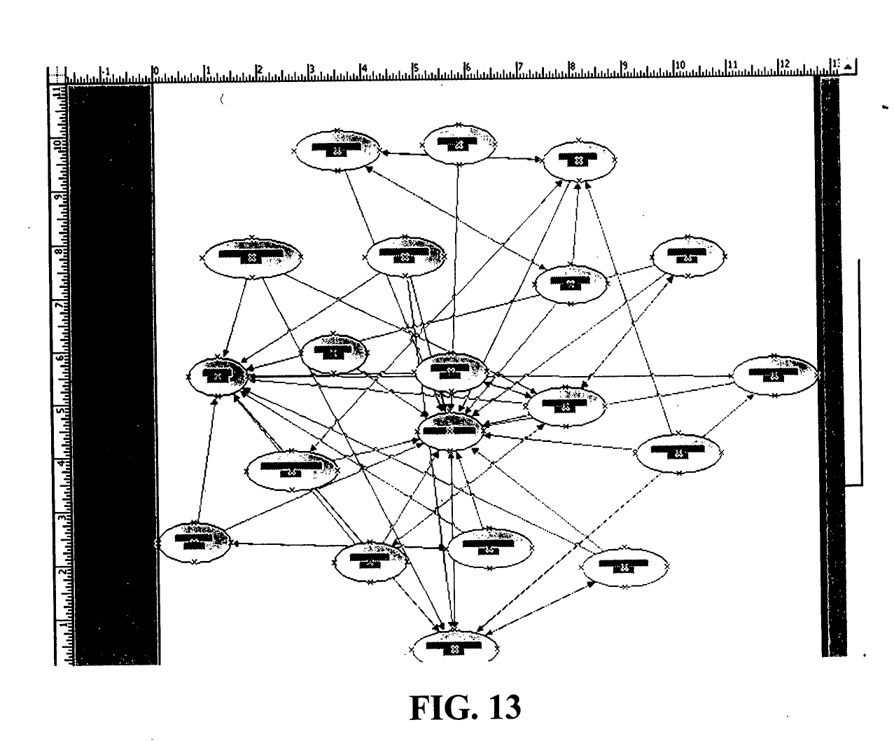

Moving on to FIG. 12, there is an exemplary user interface that demonstrates a partial view of an interactive dependency network that has been rendered by the diagramming system (100, 200). FIG. 13 illustrates a zoomed out view of the dependency network. As discussed above with respect to the decision tree template, the dependency network template allows the user to connect to data mining components (e.g., FIG. 1, 110) in order to render a dependency network diagram using a set of shapes configured or provided by the diagram component (e.g., FIG. 1, 120). The template can have options to control the shading, labels, legend, fonts, node contents, and other features of the diagram. Additional initial options not present in conventional data mining viewers will be the ability to specify shape size by an attribute, such as support, or a probability as relevant.

Though not depicted in the figure, a slider control can control link visibility when the network diagram is rendered. Users can add and remove nodes from the network diagram or remove all nodes from the network diagram and then add nodes one at a time back to the diagram. When nodes are added, they can be connected to the existing nodes as appropriate. The user can also have an option on each node to add related nodes to the network diagram, which will cause all linked nodes to be added and connected to all existing nodes in the diagram as appropriate. In addition, the user can move shapes and annotate the network diagram and also re-render the dependency network based on updates or changes in user options.

In practice, for example, imagine that the user opens the dependency network template and drags it onto a page (workspace). This action can prompt the user to specify a connection to a multidimensional data source or database, select a model, and specify rendering options. Once the model is rendered as shown in FIGS. 12 and 13, the user can annotate and modify the network diagram as needed as well as perform operations such adding related nodes and changing the link visibility.

Additionally, nodes can be interrogated through a custom user interface initiated from each node. Similar to the decision tree, the original creation user interface can be viewed again through the diagram title where the user can change options and refresh the dependency network. The dependency network template can be launched from other applications to which open connections can be accepted and maintained.

Still referring to FIGS. 12 and 13, all of the visible nodes appear to have a similar shade of blue which may represent a similar rule strength shared amongst the nodes. However, it is very likely that some of these nodes have interesting characteristics that are unique to them or shared by fewer nodes. Thus, it would be helpful to visualize some of these characteristics by changing the color of the relevant nodes or by annotating the dependency network where appropriate.

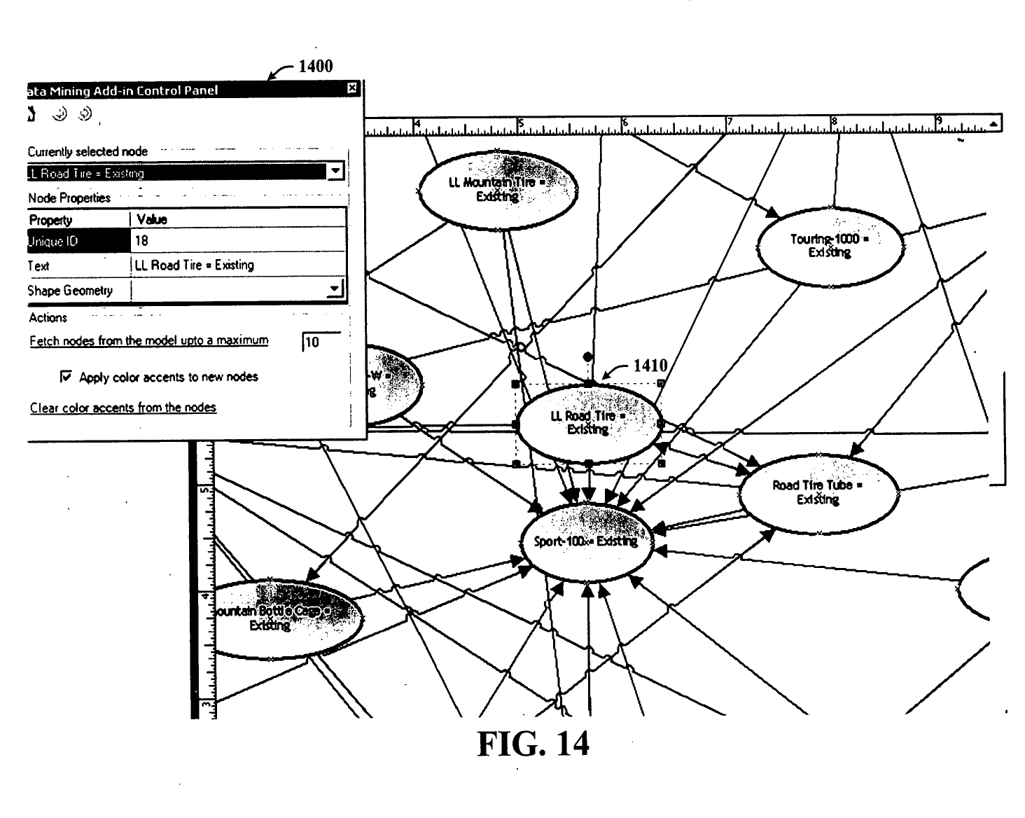

FIG. 14 demonstrates an exemplary options menu 1400 that can appear when an interactive dependency net node is clicked on to modify the content of the node, the connections to or from the node, or the placement of the node. For example, when right clicking on a highlighted node 1410, the menu 1400 can provide information about the specific node such as the identity of the node, its properties, and any actions associated with the node.

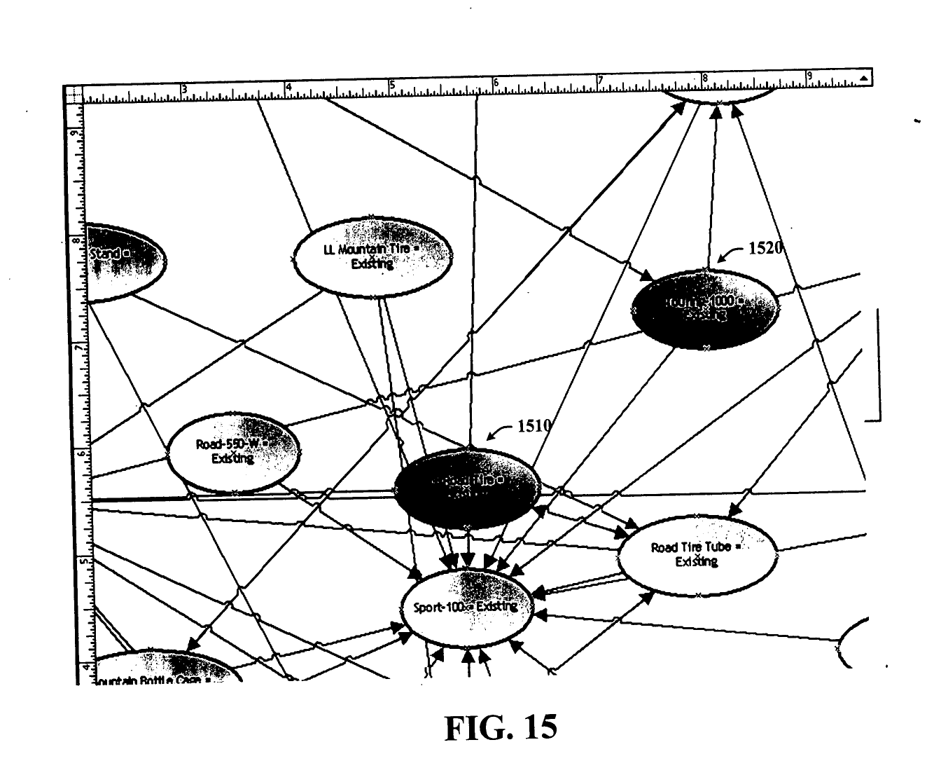

As can be seen in FIG. 15, two nodes 1510, 1520 have been modified in part by changing their color to a reddish tone. Therefore, when presenting the dependency network diagram in an electronic report or presentation, these nodes can be emphasized and may stand out from the others due to their coloring.

Various methodologies will now be described via a series of acts. It is to be understood and appreciated that the subject system and/or methodology is not limited by the order of acts, as some acts may, in accordance with the subject application, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject application.

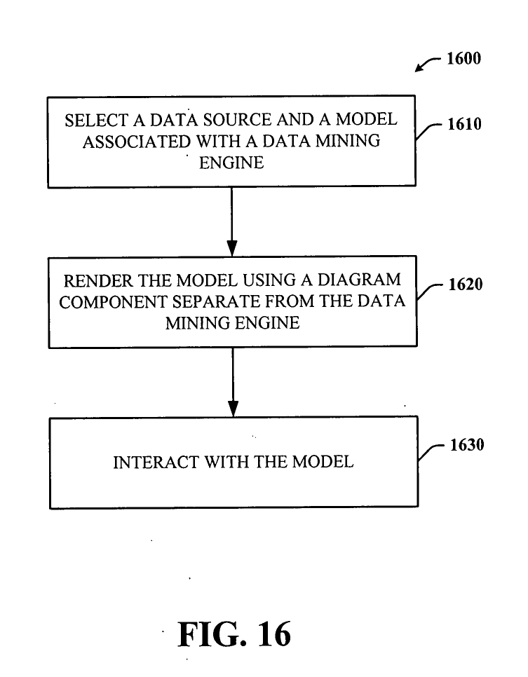

FIG. 16 is a flow diagram illustrating an exemplary method 1600 that facilitates diagramming and interacting with data mining output apart from the data mining viewer/tool. The method 1600 involves selecting a data source and model to render at 1610. At 1620, the model can be rendered using a diagram component that is separate from the data mining engine. Once the model is rendered, a user can interact with it such as by modifying or annotating it.

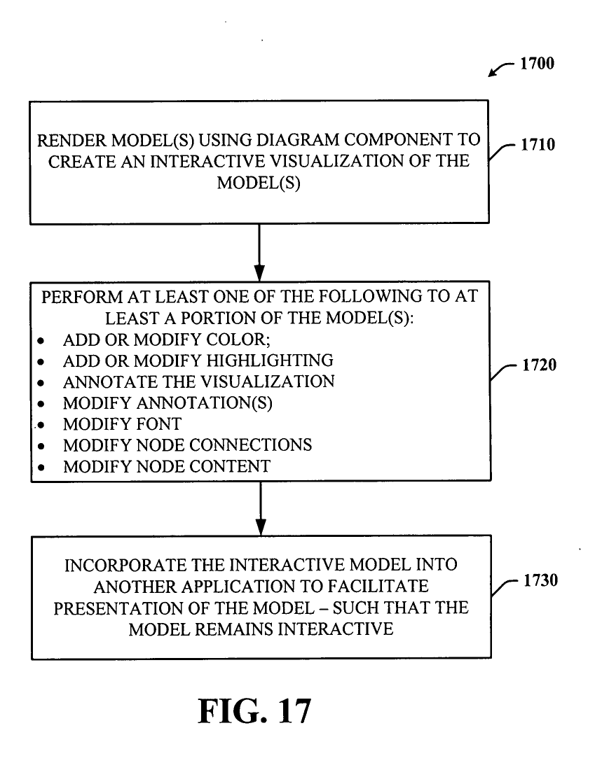

FIG. 17 is a flow diagram illustrating an exemplary method 1700 that facilitates diagramming, modifying, and/or annotating data mining output apart from the data mining viewer/tool and interacting with diagram in other (third party) applications. The method 1700 involves rendering one or more models resulting from a data mining operation using a diagram component in order to create an interactive visualization of the model at 1710. At 1720, the model can interacted with by performing at least one of the following: adding or modifying color of the node, connections, or background; adding or modifying shading or highlighting; annotating nodes or clusters of nodes; modifying annotations; modifying the fonts; modifying node connections or node content; and/or hiding or making visible some or all nodes and viewing them in a customized manner (e.g., adding them back in the model in a particular order or sequence). Node dimensions can also be modified. Finally, at 1730, the interactive visualization of the model can be incorporated into other third party applications where they can be viewed as is or further modified by the user. Thus, because the model is rendered using the diagram component (system), it can remain interactive apart from the data mining viewer in order to provide the user with more flexibility and use when presenting the model to others.

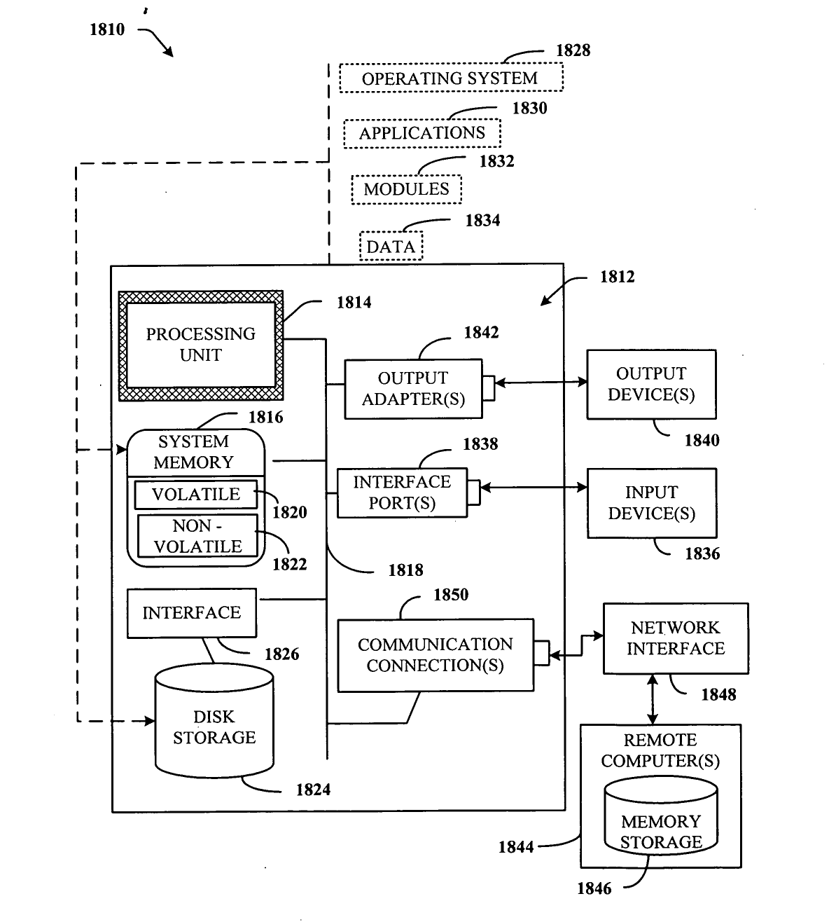

In order to provide additional context for various aspects of the subject invention, FIG. 18 and the following discussion are intended to provide a brief, general description of a suitable operating environment 1810 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1810 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 18, an exemplary environment 1810 for implementing various aspects of the invention includes a computer 1812. The computer 1812 includes a processing unit 1814, a system memory 1816, and a system bus 1818. The system bus 1818 couples system components including, but not limited to, the system memory 1816 to the processing unit 1814. The processing unit 1814 can be any of various available processors. Dual microprocessors and other multiprocessor architectures also can be employed as the processing unit 1814.

The system bus 1818 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MCA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1816 includes volatile memory 1820 and nonvolatile memory 1822. The basic input/output system (BIOS), containing the basic routines to transfer information between elements within the computer 1812, such as during start-up, is stored in nonvolatile memory 1822. By way of illustration, and not limitation, nonvolatile memory 1822 can include read only memory (ROM), programmable ROM (PROM), electrically programmable ROM (EPROM), electrically erasable ROM (EEPROM), or flash memory. Volatile memory 1820 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1812 also includes removable/nonremovable, volatile/nonvolatile computer storage media. FIG. 18 illustrates, for example a disk storage 1824. Disk storage 1824 includes, but is not limited to, devices like a magnetic disk drive, floppy disk drive, tape drive, Jaz drive, Zip drive, LS-100 drive, flash memory card, or memory stick. In addition, disk storage 1824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1824 to the system bus 1818, a removable or non-removable interface is typically used such as interface 1826.

It is to be appreciated that FIG. 18 describes software that acts as an intermediary between users and the basic computer resources described in suitable operating environment 1810. Such software includes an operating system 1828. Operating system 1828, which can be stored on disk storage 1824, acts to control and allocate resources of the computer system 1812. System applications 1830 take advantage of the management of resources by operating system 1828 through program modules 1832 and program data 1834 stored either in system memory 1816 or on disk storage 1824. It is to be appreciated that the subject invention can be implemented with various operating systems or combinations of operating systems.

A user enters commands or information into the computer 1812 through input device(s) 1836. Input devices 1836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1814 through the system bus 1818 via interface port(s) 1838. Interface port(s) 1838 include, for example, a serial port, a parallel port, a game port, and a universal serial bus (USB). Output device(s) 1840 use some of the same type of ports as input device(s) 1836. Thus, for example, a USB port may be used to provide input to computer 1812 and to output information from computer 1812 to an output device 1840. Output adapter 1842 is provided to illustrate that there are some output devices 1840 like monitors, speakers, and printers among other output devices 1840 that require special adapters. The output adapters 1842 include, by way of illustration and not limitation, video and sound cards that provide a means of connection between the output device 1840 and the system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. The remote computer(s) 1844 can be a personal computer, a server, a router, a network PC, a workstation, a microprocessor based appliance, a peer device or other common network node and the like, and typically includes many or all of the elements described relative to computer 1812. For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses communication networks such as local-area networks (LAN) and wide-area networks (WAN). LAN technologies include Fiber Distributed Data Interface (FDDI), Copper Distributed Data Interface (CDDI), Ethernet/IEEE 1102.3, Token Ring/IEEE 1102.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1850 refers to the hardware/software employed to connect the network interface 1848 to the bus 1818. While communication connection 1850 is shown for illustrative clarity inside computer 1812, it can also be external to computer 1812. The hardware/software necessary for connection to the network interface 1848 includes, for exemplary purposes only, internal and external technologies such as, modems including regular telephone grade modems, cable modems and DSL modems, ISDN adapters, and Ethernet cards.

What has been described above includes examples of the subject system and/or method. It is, of course, not possible to describe every conceivable combination of components or methodologies for purposes of describing the subject system and/or method, but one of ordinary skill in the art may recognize that many further combinations and permutations of the subject system and/or method are possible. Accordingly, the subject system and/or method are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A diagramming system that facilitates providing interactive graphical visualizations of models obtained via data mining comprising:
a data mining engine that examines and analyzes one or more sets of data and generates data mining output; and
a diagram component that creates an interactive rendering of the output to optimize visualization of the output.

2. The system of claim 1, wherein the output is represented graphically by at least one of the following: a decision tree or dependency network.

3. The system of claim 1, the diagram component comprises one or more modification components that modify at least one of an appearance or content of the output.

4. The system of claim 1, the diagram component comprises an annotation component that annotates content to the output.

5. The system of claim 1, the diagram component comprises one or more navigation components that perform at least one of the following: expand a node, collapse a node, control visibility of nodes, and alter connections to existing nodes.

6. The system of claim 1, the diagram component renders the output based in part on a selected template, the template comprising a decision tree template and a dependency network template.

7. The system of claim 6, the diagram component prompts for a selection of a database connection and model to render when at least one of the decision tree template or the dependency network template is selected and dragged to a workspace.

8. A method that facilitates providing interactive graphical visualizations of models obtained via data mining comprising:
selecting a data source and a model to render, wherein the model is an output of a data mining engine;
rendering the model using a diagram component that is separate from the data mining engine to optimize visualization and interaction with data mining output; and
interacting with the model after it is rendered.

9. The method of claim 8 further comprises incorporating the model into another application to facilitate presentation of the model whereby the model remains interactive.

10. The method of claim 8 further comprises modifying at least a portion of the model after it has been rendered to optimize visualization of the model.

11. The method of claim 10, modifying the model comprises modifying at least one of the following: color, shading, highlighting, node size, node shape, annotations, font, node connections, and node content.

12. The method of claim 8 further comprises navigating through the model by performing at least one of the following to at least one node: expanding, collapsing, hiding, and bringing back at least a subset of hidden or removed nodes.

13. The method of claim 8 further comprises customizing one or more rendering options to facilitate interaction with the model.

14. The method of claim 8 further comprises refreshing the model to update the model with any data or node changes.

15. The method of claim 8 further comprises establishing a connection between the diagram component and at least one database source to facilitate the rendering of the model apart from the data mining engine.

16. The method of claim 15 further comprises dragging at least one data mining template to a workspace whereby such dragging of the template triggers the establishing of the connection between the diagram component and at least one database source.

17. A user interface that facilitates visualizing data mining models in an interactive environment comprising:
one or more data mining templates;
an interactive workspace that receives at least one template and graphically renders selected data source based on the template;
at least one modification component that modifies appearance or content of a rendering of the selected data source; and
at least one navigation components that allows additional interaction with the rendering of the selected data source.

18. The user interface of claim 17 further comprises a database connection selection menu that allows for at least one connection to be selected and established between the workspace, data mining template, and the selected data source.

19. The user interface of claim 17, the data mining templates comprise a decision tree template and a dependency network template.

20. The user interface of claim 17 further comprises a model selection menu that allows a selection of which model to render based on the selected data source.
